(19) United States
(12) Patent Application Publication
(10) Pub. No.: US 2025/0034356 A1
(43) Pub. Date: Jan. 30, 2025

(54) COMPOSITIONS FOR USE IN LOW SURFACE-ENERGY APPLICATIONS

(71) Applicant: 3M INNOVATIVE PROPERTIES COMPANY, St. Paul, MN (US)

(72) Inventors: Georgiy Teverovskiy, St. Louis Park, MN (US); Maria A. Appeaning, St. Paul, MN (US); Colin A. Grambow, Minneapolis, MN (US)

(21) Appl. No.: 18/716,067

(22) PCT Filed: Oct. 12, 2022
(86) PCT No.: PCT/IB2022/059791

§ 371 Date: Jun. 3, 2024

Related U.S. Application Data
(60) Provisional application No. 63/290,998, filed on Dec. 17, 2021.

(51) Int. Cl. C08K 5/12; C08J 5/18

(52) U.S. Cl. CPC C08K 5/12; C08J 5/18; C08J 2367/02

(57) ABSTRACT

Fluorine-free and silicone-free small molecule additives of structure (I) where each of R¹, R², R³, and R⁴ is independently a 12 to 50 carbon alkyl group, optionally a 14 to 40 carbon alkyl group, or optionally an 18 to 30 carbon alkyl group for use in solid-state formulations, e.g., thermoplastic articles, for use in low hysteresis water repellent applications such as ultra-repellent surfaces. Methods of preparing such compositions and additives are provided.

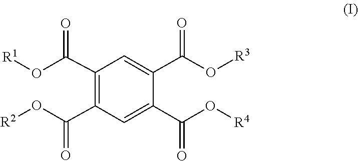

### TECHNICAL FIELD

The present disclosure broadly relates to thermoplastic compositions including long-chain alkyl aromatic esters.

### BACKGROUND

Partially fluorinated small molecule additives are known and have been used as Polymer Melt Additives (“PMAs”) in polyolefin, polyester, and polyamide co-extrusion. These PMAs can impart, for example, static and dynamic water and oil repellency and soil resistance to the resulting nonwovens, fibers, and fabrics into which they are incorporated.

U.S. Pat. No. 5,451,622 (Boardman, et al.) discloses the use of partially fluorinated amides in thermoplastic polymers to impart water and oil repellency to shaped articles, such as fibers and films and to thermoplastic mixtures of fluorochemical and thermoplastic polymer, such as polypropylene, and to the shaped articles thereof, such as fibers and films.

### SUMMARY

The present disclosure is directed to fluorine-free and silicone-free small molecule additives of structure

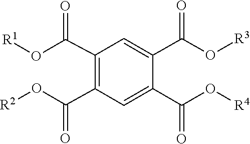

where each of R¹, R², R³, and R⁴ is independently a 12 to 50 carbon alkyl group, optionally a 14 to 40 carbon alkyl group, or optionally an 18 to 30 carbon alkyl group for use in solid-state formulations, e.g., thermoplastic articles, for use in low hysteresis water repellent applications such as, for example, ultra-repellent surfaces. Methods of preparing such compositions and additives are provided.

As used herein, the term “essentially no” amount of a material in a composition may be substituted with “less than 5 weight percent”, “less than 4 weight percent”, “less than 3 weight percent”, “less than 2 weight percent”, “less than 1 weight percent”, “less than 0.5 weight percent”, “less than 0.1 weight percent”, or “none”.

All scientific and technical terms used herein have meanings commonly used in the art unless otherwise specified.

As used in this specification and the appended claims, past tense verbs, such as, for example, “coated,” and are intended to represent structure, and not to limit the process used to obtain the recited structure, unless otherwise specified.

As used in this specification and the appended claims, the singular forms “a”, “an”, and “the” encompass embodiments having plural referents, unless the content clearly dictates otherwise.

As used in this specification and the appended claims, the term “or” is generally employed in its sense including “and/or” unless the content clearly dictates otherwise.

As used herein, “have”, “having”, “include”, “including”, “comprise”, “comprising” or the like are used in their open-ended sense, and generally mean “including, but not limited to.” It will be understood that the terms “consisting of” and “consisting essentially of” are subsumed in the term “comprising,” and the like.

Features and advantages of the present disclosure will be further understood upon consideration of the detailed description as well as the appended claims.

### DETAILED DESCRIPTION

The incorporation of a partially fluorinated small molecule can allow for in situ functionalization of a bulk material, which may obviate the need for post-processing steps, such as, for example, UV cure and thermal treatment. Such modification may be exemplified in bulk polymer co-extrusions, coatings utilizing a polymeric binder, or combinations thereof. Furthermore, partially fluorinated small molecule additives have found utility as release materials for pressure sensitive adhesives for e-beam-stable release as coatings and are being investigated as low-adhesion backings and premium release liners in solid state/co-extrusion formulations to provide, inter alia, minimal-transfer liners for silicone adhesives enabling premium release features with minimal impact to adhesive performance and the global environment.

However, because fluorinated materials have come under intense regulatory scrutiny, it may be desirable to provide fluorine-free PMAs to enable water repellent products in which fluorochemical use is restricted or disallowed. The PMAs disclosed herein are intended to replace fluorinated materials for use in such applications.

In one aspect, provided is a composition including a thermoplastic or thermoset polymer and a PMA represented by Formula I

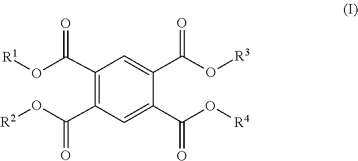

where each of R¹, R², R³, and R⁴ is independently a 12 to 50 carbon alkyl group, preferably a 14 to 40 carbon alkyl group, or more preferably an 18 to 30 carbon alkyl group. In some embodiments, each of R¹, R², R³, and R⁴ may be the same 12 to 50 carbon alkyl group, preferably the same 14 to 40 carbon alkyl group, or more preferably the same 18 to 30 carbon alkyl group. In some embodiments, the alkyl group may be a linear alkyl group.

PMAs including long-chain alkyl aromatic esters useful in embodiments of the present disclosure may be prepared by methods known to those of ordinary skill in the relevant arts, such as, for example, the methods provided in the Examples section supra. In some embodiments, PMAs useful in embodiments of the present disclosure may be prepared by combining pyromellitic dianhydride and an alcohol (e.g., a primary alcohol, a secondary alcohol, and combinations thereof) with heating in the presence of a catalyst.

Polymers useful in embodiments of the present disclosure may include both thermoplastic and thermoset polymers. Preferred thermoplastic polymers include polyesters, such as, for example, polyethylene terephthalate, polybutylene terephthalate, polyphenylene terephthalates, as well as thermoplastic polyurethanes, polyolefins, and renewable and biogradable polyesters, such as those derived from polylactide (“PLA”) and polybutylenesuccinate (“PBS”), polymers derived from copolyester resins available under the trade designation SPECTAR from Eastman Chemical Company, Kingsport, Tennessee, USA, and combinations thereof. In some embodiments, the thermoplastic polymer comprises a polyethylene terephthalate film.

A polymer composition of the present disclosure can be melted or shaped, for example by extrusion or molding, to produce shaped articles, such as fibers, films and molded articles whose surfaces exhibit excellent water repellency. The repellent polymer composition is especially useful in the preparation of nonwoven fabrics used in medical gowns and drapes, where repellency to bodily fluids is mandated. In preferred embodiments, the polymer composition comprises essentially no fluorine.

Shaped articles (e.g., fibers, films, and molded or extruded articles) prepared from compositions of the present disclosure can be made, e.g., by blending or otherwise uniformly mixing the PMAs of Formula I and a polymer, such as those described supra, for example by intimately mixing the PMA with pelletized or powdered polymer, and melt extruding the mixture into shaped articles such as pellets, fibers, or films by known methods. The PMA can be mixed per se with the polymer or can be mixed with the polymer in the form of a “masterbatch” (i.e., concentrate) of the PMA in the polymer. Masterbatches typically contain from about 10% to about 25% by weight of the PMA. Also, an organic solution of the PMA may be mixed with the powdered or pelletized polymer, the mixture dried to remove solvent, then melted and extruded into the desired shaped article. Alternatively, molten PMA (as a compound(s) or masterbatch) can be injected into a molten polymer stream to form a blend just prior to extrusion into the desired shaped article. When using thermoset resins, such as epoxy resins, urethanes and acrylates, the PMA may be mixed with the resin and cured by application of heat. Preferably such thermoset resins may be processed by reactive extrusion techniques such as are taught in U.S. Pat. No. 4,619,976 (Kotnour) and U.S. Pat. No. 4,843,134 (Kotnour).

Thermoplastic compositions containing the compounds of Formula I (i.e., PMA) may be used to provide water repellency to materials such as, for example, non-woven fabrics. Such non-woven fabrics may be particularly useful in personal protective equipment and devices, such as, for example, clothing, masks, guards, and shields. The disclosed PMAs are melt processible, i.e., suffer substantially no degradation under the melt processing conditions used to form the materials. The amount of PMA in the composition is that amount sufficient to produce a shaped article having a surface with the desired properties. Thermoplastic compositions containing the PMAs of Formula I may commonly include 0.1 wt. % to 10 wt. %, optionally, 0.5 wt. % to 7 wt %, optionally 1 wt. % to 3 wt. % of the PMA relative to the total weight of the thermoplastic polymer to which they are added.

The present disclosure focuses on the development of a fluorine-free and silicone-free additive for thermoplastic polymers that is stable at typical processing temperatures, imparts advantageous surface energy characteristics, and has minimal global environmental impact.

Objects and advantages of this disclosure are further illustrated by the following non-limiting examples, but the particular materials and amounts thereof recited in these examples, as well as other conditions and details, should not be construed to unduly limit this disclosure.

### EXAMPLES

Unless otherwise noted, all parts, percentages, ratios, etc. in the Examples and the rest of the specification are by weight. Unless otherwise indicated, materials used in the examples were obtained from commercial suppliers (e.g., Aldrich Chemical Co., Milwaukee, Wisconsin) and/or made by known methods. Materials prepared in the examples were analyzed by NMR spectroscopy and were consistent with the given structures.

### Materials Used in the Examples

| Abbreviation | Description and Source |
|---|---|
| OD | 1-octadecanol, obtained as product code 258768 from Millipore |
| | Sigma, Burlington, Massachusetts |
| UNILIN 350 | Fully saturated, long chain, linear primary alcohol with a melting |
| | point of 78° C., obtained under the trade designation “UNILIN |
| | 350” from NuCera Solutions, Barnsdall, Oklahoma |
| UNILIN 550 | Fully saturated, long chain, linear primary alcohol with a melting |
| | point of 99° C., obtained under the trade designation “UNILIN |
| | 550” from NuCera Solutions, Barnsdall, Oklahoma |
| UNICID 550 | A long chain, linear primary carboxylic acid, obtained under the |
| | trade designation “UNICID 550” from NuCera Solutions, |
| | Barnsdall, Oklahoma |
| ISOFOL 24 | 2-decyl-1-tetradecanol, obtained under the trade designation |
| | “ISOFOL 24 Alcohol” from Sasol Chemicals, Houston, Texas |
| ISOFOL 28 | 2-dodecyl-1-hexadecanol, obtained under the trade designation |
| | “ISOFOL 28 Alcohol” from Sasol Chemicals, Houston, Texas |
| ISOFOL 32 | 2-tetradecyl-1-octadecanol, obtained under the trade designation |
| | “ISOFOL 32 Alcohol” from Sasol Chemicals, Houston, Texas |
| PMDA | Pyromellitic dianhydride, obtained as product code 412287 from |
| | Millipore Sigma, Burlington, Massachusetts |
| Mesic Acid | Methanesulfonic acid, obtained as product code 471356 from |
| | Millipore Sigma, Burlington, Massachusetts |
| PTA Clear 62 | PET resin available as product code 41-5599-0286-5 from 3M |
| | Company, St. Paul, Minnesota |
| PCTg | Copolyester resin obtained under the trade designation |
| | “SPECTAR CLEAR COPOLYESTER VM318, from Eastman |
| | Chemical Company, Kingsport, Tennessee |
| Xylenes | Xylenes, can be obtained from Millipore Sigma, Burlington, |
| | Massachusetts |
| TEA | Triethylamine, can be obtained from Millipore Sigma, |
| | Burlington, Massachusetts |

### Test Methods

### Determination of F Surface Concentration Via XPS

The example surfaces were examined using X-ray Photoelectron Spectroscopy (“XPS”) also known as Electron Spectroscopy for Chemical Analysis (“ESCA”) at an approximate photoelectron takeoff angle of 450 unless otherwise stated.

### Contact Angle Measurement

Water contact angles were measured using a Ramé-Hart goniometer (Ramé-Hart Instrument Co., Succasunna, NJ). Advancing (θ adv) and receding (θ rec) angles were measured as probe fluid was supplied via a syringe into or out of sessile droplets (drop volume ˜10 μL). Measurements were taken at three different spots on each surface, and the reported measurements are the averages of the 9 values for each sample (3 measurements per spot, for advancing and receding independently).

### Preparatory Examples

### Preparation of Additive 1 (AD1)

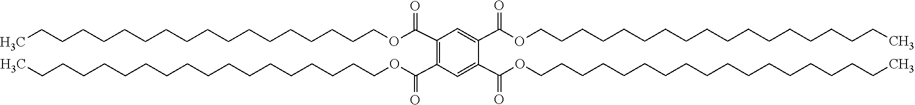 [SMILES: CCCCCCCCCCCCCCCCCCOC(=O)c1cc(C(=O)OCCCCCCCCCCCCCCCCCC)c(C(=O)OCCCCCCCCCCCCCCCCCC)cc1C(=O)OCCCCCCCCCCCCCCCCCC]

1-Octadecanol (124 g, 458.5 mmol), pyromellitic dianhydride (25.0 g, 114.62 mmol), xylenes (115 mL), and mesic acid (0.074 mL, 1.15 mmol) were added to a 1 L round bottom flask equipped with a magnetic stir bar, Dean-Stark apparatus, and reflux. The reaction flask was wrapped in glass wool and the mixture was slowly heated to 130° C. at which point water began to collect in the Dean-Stark apparatus. The temperature was increased to 160° C. over a two-hour period of time and the mixture was allowed to stir over night at 160° C. The reaction mixture was cooled to 100° C. and triethylamine (0.160 mL, 1.15 mmol) was added to quench the catalyst. The Dean-Star apparatus and reflux condenser were then replaced with a distillation head equipped with thermometer, vacuum adapter, and receiving flask. Solvent was removed via distillation under reduced pressure to afford AD1 as a white solid.

### Preparation of Additive 2 (AD2)

Unilin 350 (179.26 g, 458.46 mmol), pyromellitic dianhydride (25.0 g, 114.62 mmol), xylenes (115 mL), and mesic acid (0.074 mL, 1.15 mmol) were added to a 1 L round bottom flask equipped with a magnetic stir bar, Dean-Stark apparatus, and reflux condenser. The reaction flask was wrapped in glass wool and the mixture was slowly heated to 130° C., at which point water began to collect in the Dean-Stark apparatus. The temperature was increased to 160° C. over a two hour period and the mixture was allowed to stir over night at 160° C. The reaction mixture was cooled to 100° C. and triethylamine (0.160 mL, 1.15 mmol) was added to quench the catalyst. The Dean-Star apparatus and reflux condenser were then replaced with a distillation head equipped with thermometer, vacuum adapter, and receiving flask. Solvent was removed via distillation under reduced pressure to afford AD2 as a dark colored solid.

### Preparation of Additive 3 (AD3)

Unilin 550 (196 g, 275 mmol), pyromellitic dianhydride (15.0 g, 68.8 mmol), xylenes (59 mL), and mesic acid (0.044 mL, 0.69 mmol) were added to a 1 L round bottom flask equipped with a magnetic stir bar, Dean-Stark apparatus, and reflux condenser. The reaction flask was wrapped in glass wool and the mixture was slowly heated to 130° C., at which point water began to collect in the Dean-Stark apparatus. The temperature was increased to 160° C. over a two-hour period and the mixture was allowed to stir over night at 160° C. The reaction mixture was cooled to 100° C. and triethylamine (0.096 mL, 0.688 mmol) was added to quench the catalyst. The Dean-Star apparatus and reflux condenser were then replaced with a distillation head equipped with thermometer, vacuum adapter, and receiving flask. Solvent was removed via distillation under reduced pressure to afford AD3 as a white solid.

### Preparation of Additive 4 (AD4)

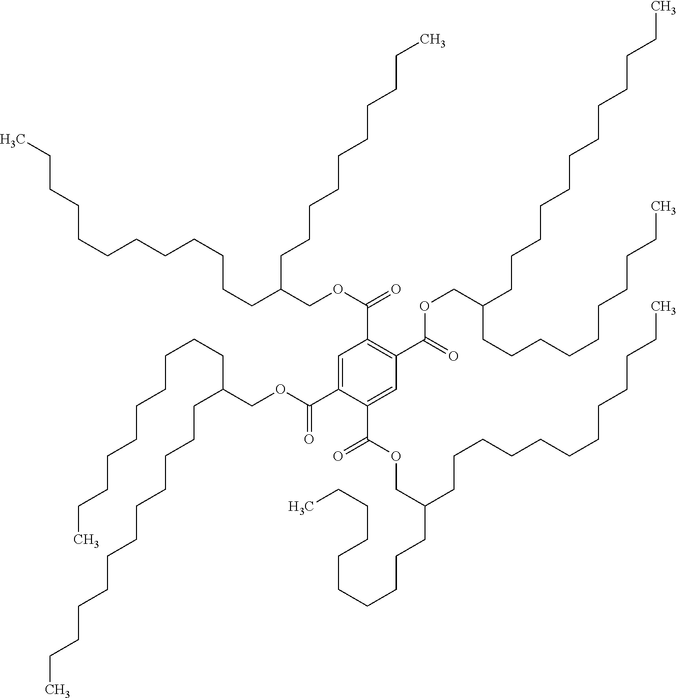 [SMILES: CCCCCCCCCCCCC(CCCCCCCCCC)COC(=O)c1cc(C(=O)OCC(CCCCCCCCCC)CCCCCCCCCCCC)c(C(=O)OCC(CCCCCCCCCC)CCCCCCCCCCCC)cc1C(=O)OCC(CCCCCCCCCC)CCCCCCCCCCCC]

ISOFOL 24 (102 g, 288.5 mmol), pyromellitic dianhydride (15.7 g, 72.12 mmol), xylenes (115 mL), and mesic acid (0.047 mL, 0.72 mmol) were added to a 1 L round bottom flask equipped with a magnetic stir bar, Dean-Stark apparatus, and reflux condenser. The reaction flask was wrapped in glass wool and the mixture was slowly heated to 130° C., at which point water began to collect in the Dean-Stark apparatus. The temperature was increased to 160° C. over a two hour period and the mixture was allowed to stir over night at 160° C. The reaction mixture was cooled to 100° C. and triethylamine (0.101 mL, 0.72 mmol) was added to quench the catalyst. The Dean-Star apparatus and reflux condenser were then replaced with a distillation head equipped with thermometer, vacuum adapter, and receiving flask. Solvent was removed via distillation under reduced pressure to afford AD4 as a dark liquid.

### Preparation of Additive 5 (AD5)

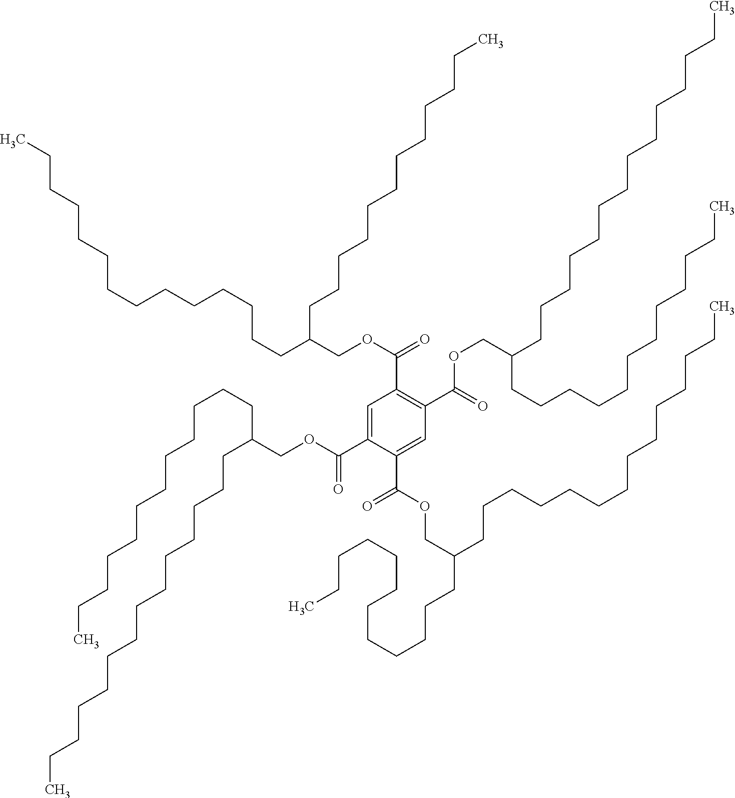 [SMILES: CCCCCCCCCCCCCCC(CCCCCCCCCCCC)COC(=O)c1cc(C(=O)OCC(CCCCCCCCCCCC)CCCCCCCCCCCCCC)c(C(=O)OCC(CCCCCCCCCCCC)CCCCCCCCCCCCCC)cc1C(=O)OCC(CCCCCCCCCCCC)CCCCCCCCCCCCCC]

ISOFOL 28 (150.7 g, 366.78 mmol), pyromellitic dianhydride (20.0 g, 91.69 mmol), xylenes (92 mL), and mesic acid (0.060 mL, 0.917 mmol) were added to a 1 L round bottom flask equipped with a magnetic stir bar, Dean-Stark apparatus, and reflux condenser. The reaction flask was wrapped in glass wool and the mixture was slowly heated to 130° C. at which point water began to collect in the Dean-Stark apparatus. The temperature was increased to 160° C. over a two hour period and the mixture was allowed to stir over night at 160° C. The reaction mixture was cooled to 100° C. and triethylamine (0.128 mL, 0.917 mmol) was added to quench the catalyst. The Dean-Star apparatus and reflux condenser were then replaced with a distillation head equipped with thermometer, vacuum adapter, and receiving flask. Solvent was removed via distillation under reduced pressure to afford AD5 as a dark colored liquid.

### Preparation of Additive 6 (AD6)

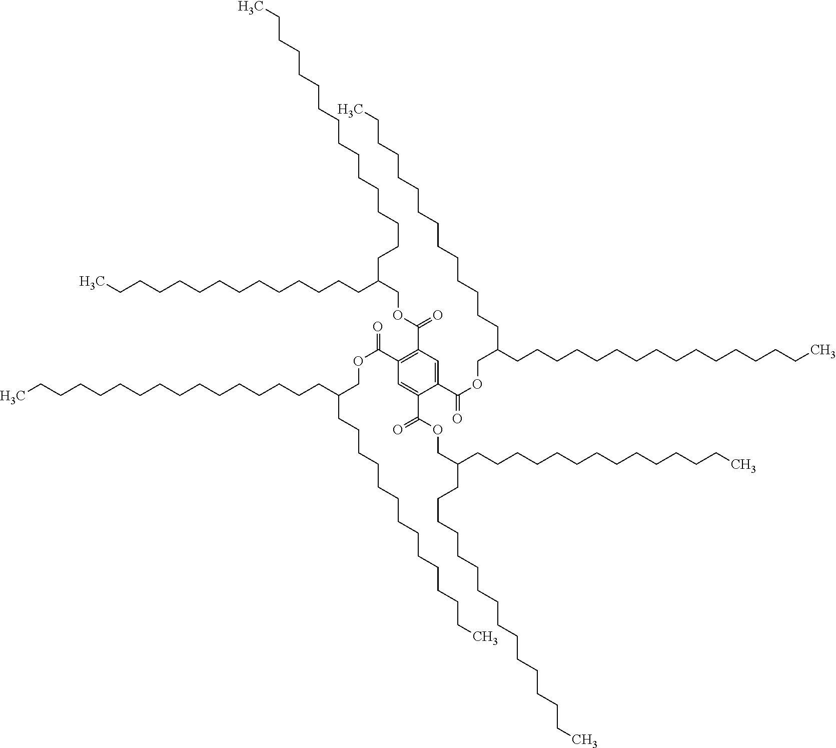 [SMILES: CCCCCCCCCCCCCCCCC(CCCCCCCCCCCCCC)COC(=O)c1cc(C(=O)OCC(CCCCCCCCCCCCCC)CCCCCCCCCCCCCCCC)c(C(=O)OCC(CCCCCCCCCCCCCC)CCCCCCCCCCCCCCCC)cc1C(=O)OCC(CCCCCCCCCCCCCC)CCCCCCCCCCCCCCCC]

ISOFOL 32 (171.2 g, 366.77 mmol), pyromellitic dianhydride (20.0 g, 91.69 mmol), xylenes (91.7 mL), and mesic acid (0.060 mL, 0.917 mmol) were added to a 1 L round bottom flask equipped with a magnetic stir bar, Dean-Stark apparatus, and reflux condenser. The reaction flask was wrapped in glass wool and the mixture was slowly heated to 130° C., at which point water began to collect in the Dean-Stark apparatus. The temperature was increased to 160° C. over a two hour period and the mixture was allowed to stir over night at 160° C. The reaction mixture was cooled to 100° C. and triethylamine (0.128 mL, 0.917 mmol) was added to quench the catalyst. The Dean-Star apparatus and reflux condenser were then replaced with a distillation head equipped with thermometer, vacuum adapter, and receiving flask. Solvent was removed via distillation under reduced pressure to afford AD6 as an amber liquid.

### Preparation of Comparative Additive 1 (CA1)

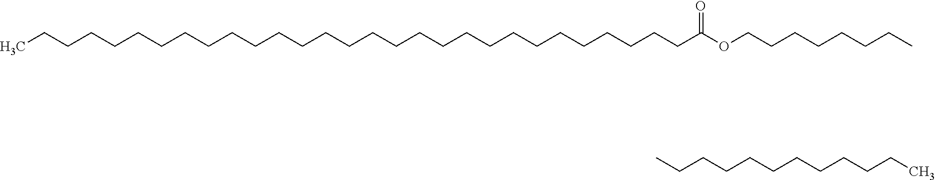

1-Octadecanol (31 g, 114.8 mmol), UNICID 550 (80 g, 114.8 mmol), xylenes (225 mL), and mesic acid (0.113 mL, 1.7 mmol) were added to a 1 L round bottom flask equipped with a magnetic stir bar, Dean-Stark apparatus, and reflux. The reaction flask was wrapped in glass wool and the mixture was slowly heated to 130° C. at which point water began to collect in the Dean-Stark apparatus. The temperature was increased to 160° C. over a two hour period of time and the mixture was allowed to stir over night at 160° C. The reaction mixture was cooled to 100° C. and triethylamine (0.240 mL, 1.7 mmol) was added to quench the catalyst. The Dean-Star apparatus and reflux condenser were then replaced with a distillation head equipped with thermometer, vacuum adapter, and receiving flask. Solvent was removed via distillation under reduced pressure to afford CA1 as a white solid.

### Preparation of the Modified (Additive) PET Films:

Modified PET films of a 24 mil thickness were extruded in a dual layer construction (1:9) top layer to bottom layer. The top layer (also referred to as the “skin” layer) was co-extruded with additive and PCTg, and the bottom layer consisted solely of PTA Clear 62 available from 3M Company, St. Paul, MN. The films were extruded using an 18 mm twin screw extruder equipped with three independent feeders. Feeder A contained the PTA Clear 62 resin pellets for the bottom layer, Feeder B contained PCTg for the top layer, and Feeder C contained additive for incorporation into the top layer. The CE-A material is a two-layer construction with PCTg as the skin layer with no additive present (10% PCTg and 90% PTA Clear 62). CE-B and EX-1 to EX-6 included additive in the PCTg layer (2.5 wt. % relative to the total weight of the thermoplastic in the top layer), as indicated in Table 1. Conditions: The 5 inch by 5 inch squares were simultaneously biaxially oriented at a stretching ratio of 3.35 in the machine direction and 3.58 in the transverse direction with preheating temperatures at 96° C. for 15 seconds and thermally set at 212° C. for 15 seconds.

Examples were tested according to the Contact Angle Measurements procedures above. Results are reported in Table 1 below.

TABLE 1
Contact Angle Measurements

| | | Θ ADV | Θ REC | Θ ADV | Θ REC |
|---|---|---|---|---|---|
| Film | Additive | Water | Water | Hexadecane | Hexadecane |
| CE-A | — | 85° | 66° | <10° | <10° |
| CE-B | CA1 | 118° | 104° | 34° | <10° |
| EX-1 | AD1 | 111° | 108° | 42° | <4° |
| EX-2 | AD2 | 102° | 83° | 21° | 0° |
| EX-3 | AD3 | 100° | 65° | 0° | 0° |
| EX-4 | AD4 | 92° | 67° | 0° | 0° |
| EX-5 | AD5 | 97° | 69° | 0° | 0° |
| EX-6 | AD6 | 98° | 67° | 0° | 0° |

EX-1 has a measured hysteresis of 3 degrees, as compared with CE-B, which is 14 degrees.

### Determination of F Surface Concentration Via XPS

No fluorochemical was detected for any examples.

All cited references, patents, and Patent Applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of

1. A composition comprising:
a thermoplastic polymer; and
an additive represented by the structure 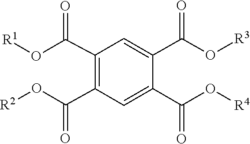
wherein each of R¹, R², R³, and R⁴ is independently a 12 to 50 carbon alkyl group, preferably a 14 to 40 carbon alkyl group, or more preferably an 18 to 30 carbon alkyl group.

2. The composition of claim 1, wherein the thermoplastic polymer comprises a polyethylene terephthalate film.

3. The composition of claim 1, wherein each of R¹, R², R³, and R⁴ is the same 12 to 50 carbon alkyl group, preferably the same 14 to 40 carbon alkyl group, or more preferably the same 18 to 30 carbon alkyl group.

4. The composition of claim 1, wherein the alkyl group is a linear alkyl group.

5. The composition of to claim 1, wherein the additive is the product of pyromellitic dianhydride and an alcohol.

6. The composition of claim 1, wherein the alcohol is selected from the group consisting of a primary alcohol, a secondary alcohol, and combinations thereof.

7. The composition of claim 1, wherein composition comprises include 0.1 wt. % to 10 wt. %, optionally, 0.5 wt. % to 7 wt %, optionally 1 wt. % to 3 wt. % of the additive relative to the weight of the thermoplastic polymer in which it is found.

8. The composition of claim 1, wherein the composition comprises essentially no fluorine.

9. An extruded article comprising the composition claim 1.

10. The extruded article of claim 9, wherein the extruded article is a film.

11. A non-woven fabric comprising the composition claim 1.

12. A personal protective device comprising the non-woven fabric of claim 11.

13. A method of preparing a composition, the method comprising:
combining a thermoplastic polymer with an additive to provide the composition, the additive represented by the structure 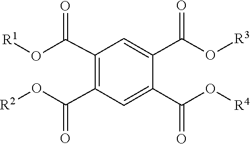
wherein each of R¹, R², R³, and R⁴ is independently a 12 to 50 carbon alkyl group, preferably a 14 to 40 carbon alkyl group, or more preferably an 18 to 30 carbon alkyl group.

14. The method of claim 13, wherein the thermoplastic polymer comprises a polyethylene terephthalate film.

15. The method of claim 13, wherein each of R¹, R², R³, and R⁴ is the same 12 to 50 carbon alkyl group, preferably the same 14 to 40 carbon alkyl group, or more preferably the same 18 to 30 carbon alkyl group.

16. The method of claim 13, wherein the alkyl group is a linear alkyl group.

17. The method of claim 13, wherein the additive is the product of pyromellitic dianhydride and an alcohol.

18. The method of claim 13, wherein the alcohol is selected from the group consisting of a primary alcohol, a secondary alcohol, and combinations thereof.

19. The method of claim 13, wherein composition comprises include 0.1 wt. % to 10 wt. %, optionally, 0.5 wt. % to 7 wt %, optionally 1 wt. % to 3 wt. % of the additive relative to the weight of the thermoplastic polymer in which it is found.

20. The method of claim 13, wherein the composition comprises essentially no fluorine.
